(19) United States
(12) Patent Application Publication
(10) Pub. No.: US 2014/0330642 A1
(43) Pub. Date: Nov. 6, 2014

(54) SYSTEM AND METHOD FOR END USER ACTIVATED CONTEXTUAL MOBILE ADVERTISING AND OPPORTUNITY MATCHING PLATFORM

(71) Applicant: CDEMO MOBILE SOLUTIONS LTD., Calgary (CA)

(72) Inventor: Qiang HU, Calgary (CA)

(73) Assignee: CDEMO MOBILE SOLUTIONS LTD., Calgary (CA)

(21) Appl. No.: 14/267,138

(22) Filed: May 1, 2014

Related U.S. Application Data
(60) Provisional application No. 61/818,262, filed on May 1, 2013.

(51) Int. Cl. G06Q 30/02

(52) U.S. Cl. CPC G06Q 30/0253
USPC 705/14.51

(57) ABSTRACT

A system and method are disclosed for the creation of a contextual mobile advertising and opportunity matching platform (CMAP) that provides contextually relevant advertising, lead generation, feedback, quotation or offers for goods and/or services, collaboration, or other contextually relevant interaction between parties to opportunity receivers based upon data generator sourced or generated values, inferences or data. The system analyzes and processes data obtained from and/or about a data generator, and uses this data to either directly determine and deliver a contextual opportunity to the opportunity receiver or match to a list of associated third party opportunity publishers who may be able to provide a relevant contextual opportunity to the opportunity receiver.

### CROSS-REFERENCE TO RELATED APPLICATIONS

This application claims the benefits under 35 U.S.C. 119(e) of the U.S. Provisional Application Ser. No. 61/818,262, filed on MAY 1, 2013, the subject matter of which is incorporated fully herein by reference.

### FIELD OF THE DISCLOSURE

The present disclosure generally relates to a method and a computer network system for contextual mobile advertising, and in particular, relates to a method and a computer network system for identifying opportunities and establishing transactions between two parties.

### BACKGROUND OF THE DISCLOSURE

Internet commerce, such as online purchases of goods and services via mobile devices, is becoming a persistent and pervasive part of life with the growing popularity of cellular data networks and expansive wired/wireless networks, and diversified methods of Internet accessing, interaction and collaboration. Advertisers, merchants, educational institutions, governments and anyone needing access to consumers, clients, goods, peers, services or information in general have turned towards smartphones, mobile platforms and other methods of sharing ideas and information and accessing the internet as a way of attracting new users/clients or of more easily sharing and collaborating with others. With the smartphone market expanding toward six billion dollars in 2012 and internet commerce and mobile payments as a whole approaching hundreds of billions of dollars in annual transactions with substantial yearly increases forecasted, the ability to capitalize on these markets and mobile devices, which remain constantly with users, is an important target.

In order to be able to do this effectively and efficiently and to best capitalize their return on investment (“ROI”), there is a demonstrated need for advertisers, merchants and other institutions to have methods that target specific users with data relevant to those users' interests and/or needs within the immediate circumstances or settings.

### SUMMARY OF THE DISCLOSURE

The System and Method for End User Activated Contextual Mobile Advertising and Opportunity Matching Platform (CMAP) is a system and method for the facilitation and/or generation of contextually relevant data that is analyzed and compiled into packets of information, referred to as “Opportunity Profiles” which can be easily shared with third parties. The CMAP system generates Opportunity Profiles based upon specific input data delivered to the system from any source, including data which can originate from CMAP data collection processes or interfaces, or any other data collection/generation process, system or third party platforms or services that can collect relevant contextual information sourced or generated from or about a specific end-user, system or asset. The CMAP system is a platform that can be active in or accessed from multiple environments, systems and devices including Personal Computers, mobile devices, internet-based or accessible platforms, wearable computers, or any information manufacturing machine and multiple operating systems and any other interface or method in which a user can access CMAP generated output or any other method that can be used to generate and transmit data to the CMAP system.

Data received by the CMAP system from the user, denoted as the Data Generator, and opportunity inferences compiled from such data, determines relevant and targeted feedback in the form of Contextual Opportunities to be delivered to the Opportunity Receiver (being the Data Generator or a different but relevant party), either automatically from the CMAP system when applicable, or from associated Opportunity Publishers (such as one or more service providers or vendors) who provide Contextual Opportunities based on specific data captured from or about the Data Generator. These Contextual Opportunities are submitted responses which are delivered automatically from the CMAP system or based on feedback from Opportunity Publishers' responses to an Opportunity Profile, which in turn are based upon input data collected from or about the Data Generator which the CMAP system uses to match to and generate a list of specific Opportunity Publishers offering Contextual Opportunities relevant to the Data Generator and to the Data Generator's and/or the Opportunity Receiver's geographical location, if applicable. Weighted algorithms and other factors defined within the CMAP system are applied to this list of Opportunity Publishers' Contextual Opportunity offerings, rewarding them with higher placement or visibility of their Contextual Opportunity to the Opportunity Receiver. The Opportunity Receiver may select an Opportunity Publisher for a Contextual Opportunity, and then the CMAP system assists them to establish a transaction therebetween.

The system and technology disclosed herein is related to the creation of a Contextual Mobile Advertising and Opportunity Matching Platform (CMAP) that provides contextually relevant advertising, lead generation, feedback, quotation or offers for goods and/or services, collaboration, or other contextually relevant interaction between parties, of which any or all collectively are referred to as “Contextual Opportunities”, to Opportunity Receivers based upon Data Generator sourced or generated values, inferences or data. More particularly, the present technology analyzes and processes data obtained from and/or about a Data Generator directly from the system's own data collection interfaces and processes or from other sources or third-party systems. Data collected or submitted as users interact with the technology or other data generation sources is specific to the Data Generator and results in targeted output in the form of Opportunity Profiles and resultant Contextual Opportunities. The system uses this data to either directly determine and deliver a Contextual Opportunity to the Opportunity Receiver or match to a list of associated third party Opportunity Publishers who may be able to provide a relevant Contextual Opportunity to the Opportunity Receiver.

In embodiments, at least one contextual transaction opportunity is identified from the primary request received from a Data Generator, and is established between an opportunity receiver (being the Data Generator or a relevant third-party), and a service provider, collaborator or vendor, as an opportunity publisher. Based on the contextual transaction opportunity identified, the system may notify the opportunity publisher to provide further information for facilitating the establishment of the transaction or collaboration.

If needed, specific and relevant information from an Opportunity Profile is provided to this list of Opportunity Publishers, allowing them to input or respond with any specific information required to provide a matching and accurate Contextual Opportunity to the Opportunity Receiver, targeted to and based on the specific info provided by or about the Data Generator. The Opportunity Receiver is then able to view, purchase or otherwise act on the matching Contextual Opportunity in the form of an advertisement, offer, lead, feedback, goods or services quotation, offering, collaboration or other opportunity provided by these Opportunity Publishers. As an Opportunity Publisher participates in responding to these targeted inquiries and providing relevant matching Contextual Opportunities, this participation and any other related or relevant factors are used and analyzed by the system in order to grant the Opportunity Publisher more or less prominence or visibility to the Opportunity Receiver of the specific Opportunity Publisher's Contextual Opportunity offering.

One embodiment of the present technology provides a system and method for contextual mobile advertising and providing other Contextual Opportunities on a mobile device, PC platform and other internet-based or accessible platforms, systems, wearable computers, or any information manufacturing machine and multiple operating systems and any other method in which a user can access CMAP generated output or any other method which can be used to generate and transmit data to CMAP. CMAP interacts, shares or provides data to three main categories of systems or users; the Data Generator, Opportunity Publisher, and Opportunity Receiver.

The Data Generator is a user, system, material object or physical asset which generates data or, from or about which data is sourced, or compiled, for use as input data to CMAP. The Data Generator can sometimes be referred to as an “End User”, but is not always an actual person and may be a system, material object or physical asset.

The Opportunity Publisher is an automated process or components within CMAP or targeted independent systems, users or other third parties that receive information about a Data Generator from CMAP and which provide a Contextual Opportunity for CMAP to deliver to the Opportunity Receiver.

An Opportunity Receiver is the receiver of CMAP qualified and generated Contextual Opportunities. The Opportunity Receiver sometimes is also the Data Generator, but is also sometimes a separate and distinct third party or system.

During operation, the platform gathers contextual information based on the specific input data provided by or otherwise obtained from or about the Data Generator. As the Data Generator continues to provide input and data to the platform, the technology determines activities or relevant products/services based on this data, whether this data is in the form of questions and answers, photos, video or other raw data, and generates an Opportunity Profile. The system may or may not make inferences based on the data provided, and the system matches data provided by the Data Generator to Opportunity Profiles created by or available from Opportunity Publishers. When the system identifies a specific opportunity using an Opportunity Profile and matches to an opportunity or offering from an Opportunity Publisher, targeted feedback, which the system refers to as a “Contextual Opportunity”, is provided to the Opportunity Receiver. The CMAP system may make logical assumptions and inferences based on the available data and Opportunity Profile, but most often matches occur based on the specific data entered into the system by, from or about the Data Generator.

The Contextual Opportunity, depending on system configurations and the data analyzed, is either generated directly from the platform or is based on specific feedback or submitted responses from third parties associated with the system, called Opportunity Publishers, who the system determines as candidates for being able to supply a Contextual Opportunity matching the specific Opportunity Profile, taking into account the Data Generator sourced information and the Opportunity Receiver's needs. If needed, Opportunity Publishers are notified and provided with information and data which they might need in order to provide specific targeted feedback relating to the Opportunity Profile. This notification is presented to all potential Opportunity Publishers who are associated with CMAP and submitted information to the system and who the system determines as a potential match to the specific request as determined by the Opportunity Profile. These notified Opportunity Publishers are then able to respond and submit to CMAP the required info, which generates a Contextual Opportunity allowing the Opportunity Publisher to effectively target specific quotes, offers, feedback, collaborations, advertisements and/or other opportunities to each Opportunity Receiver. The technology then selects one or more Opportunity Publishers' Contextual Opportunities to be displayed to the user directly on the system or platform that the Opportunity Receiver is accessing or using, or delivered in some other way as desired by the Opportunity Receiver or as otherwise configured and defined within the system, and which is specific to the Opportunity Profile's calculated needs or desires of the Opportunity Receiver and/or Data Generator and which are within the Data Generator's or Opportunity Receiver's specified geographical location, if this is relevant to the request, as determined within the Opportunity Profile.

As an Opportunity Receiver is presented with a list of Contextual Opportunities generated and provided by the Contextual Mobile Advertising Platform they are able to select, purchase, obtain more information or otherwise act upon any or all of the Contextual Opportunities of interest. If, for example, the Data Generator is utilizing a system for capturing data about the condition of a car in the form of pass/fail questions, each pass/fail question answered can be a data point used to create a contextual Opportunity Profile for the user or the specific vehicle. As well, each answer provided in the pass/fail section can be a trigger essentially activated by the Data Generator, enabling advertisement by vendors or other Contextual Opportunities to be displayed, targeted to the stated needs of the user or condition of the car. This information is analyzed by the Contextual Mobile Advertising and Opportunity Matching Platform creating an Opportunity Profile and, if needed, then transmitted to participating Opportunity Publishers, who, using the contextual data provided, are able to provide feedback and participate in advertising or other opportunity directly to the Opportunity Receiver. A specific example of this: A Data Generator flags a windshield as broken while capturing data on a specific Year/Make/Model of automobile. CMAP uses this data combined with other factors, compares it to a list of Opportunity Publishers who have indicated that they provide service to the geographical region where the Data Generator assessed the car and develops an Opportunity Profile with the Year/Make/Model and other relevant info for the car, indicating a quote for a new windshield is desired. Either based on pre-set information configured in CMAP by the Opportunity Publisher or from direct feedback returned to CMAP by the Opportunity Publisher in response to the Opportunity Profile, windshield replacement quotes for that specific automobile are delivered back to the Opportunity Receiver. The Opportunity Receiver then has the option of obtaining more information and/or completing the purchase of the windshield directly from their chosen Opportunity Publisher.

It is an object of this technology to provide Data Generators with a Contextual Mobile Advertising and Opportunity Matching platform triggered by data input, which ultimately generates Contextual Opportunities from specific lists of Opportunity Publishers, which are returned to Opportunity Receivers, which may or may not be the original Data Generators.

It is an object of this technology to provide Opportunity Receivers with a contextual advertising or opportunity matching technology triggered by needs established from data input to and analyzed by the Contextual Mobile Advertising and Opportunity Matching Platform.

It is a further object of this technology to provide Opportunity Receivers with a contextual advertising or opportunity matching technology where Contextual Opportunities are triggered by data generated from or about the Data Generator, and relevant to the Data Generator's specifications, needs or desires.

It is a further object of this technology to provide participating Opportunity Publishers a contextual advertising or opportunity matching platform where advertisements, quotes for goods and services and other Contextual Opportunities can be targeted specifically to an Opportunity Receiver's specifications, needs or desires.

It is a further object of this technology to provide participating Opportunity Publishers a contextual advertising or opportunity matching platform where advertisements, quotes for goods and services and other Contextual Opportunities are the result of Data Generator activated triggers.

It is a further object of this technology to provide a platform that allows Opportunity Publishers to advertise or otherwise provide Contextual Opportunities based on specific contextual data captured from or about the Data Generator and which is also relevant to the services, goods, collaborations or other Contextual Opportunities the Opportunity Publisher is able to provide.

It is a further object of this technology to provide a platform that allows Opportunity Publishers to advertise or otherwise provide Contextual Opportunities based on specific contextual data captured from or about the Data Generator and which is also relevant to the services, goods, collaborations or other Contextual Opportunities the Opportunity Publisher is able to provide, and weighted or sorted or classified by the Opportunity Publisher's participation in Data Generator activated triggers and needs, in communications with the end user and other factors.

According to one aspect of this disclosure, there is provided a computerized method for establishing a transaction, comprising: receiving data from a first user regarding a request; identifying, by analyzing the received data, at least one contextual transaction opportunity additional to said request; identifying at least one opportunity publisher for the at least one contextual transaction opportunity; sending the at least one contextual transaction opportunity to the at least one opportunity publisher; determining whether or not further information related to the at least one contextual transaction opportunity is required from the at least one opportunity publisher; requesting the at least one opportunity publisher to provide further information related to the at least one contextual transaction opportunity, if further information related thereto is required; delivering, to a receiver, information relevant to the at least one opportunity publisher; receiving, from the receiver, a selection of one of the at least one opportunity publisher; and establishing a transaction between the receiver and the selected one of the at least one opportunity publisher.

In some embodiments, the receiver is the first user or system. In some alternative embodiments, the receiver is a second user or system different to the first user or system.

According to another aspect of this disclosure, the method further comprises: identifying a third user or system relevant to said primary request; and establishing a transaction between the first user or system and the third user or system.

According to another aspect of this disclosure, identifying at least one contextual transaction opportunity additional to said request comprises: presenting at least one question to the first user or system; receiving answer from said first user or system regarding the at least one question; and identifying at least one contextual transaction opportunity from the received answer.

### BRIEF DESCRIPTION OF THE DRAWINGS

FIG. 1 illustrates a high-level hardware structure of a computer network system for establishing investment transactions according to one embodiment;

FIG. 2 shows the hardware structure of a computing device of FIG. 1;

FIG. 3 shows a software structure of the computer network system of FIG. 1, with the illustration of the interaction between the one or more server computers and client computing devices;

FIG. 4 shows the detail of requesting and receiving data or feedback from an Opportunity Publisher;

FIG. 5 shows the opportunities delivery process;

FIG. 6 illustrates an example of the complete CMAP process; and

FIGS. 7A to 7I show an example scenario of real estate home inspector data input to the CMAP system, for further illustrating the functions of the system of FIG. 1;

### DETAILED DESCRIPTION

Generally, the system described herein executes computer-readable code for creating a Contextual Mobile Advertising and Opportunity Matching Platform (“CMAP”) that provides contextually relevant advertising, lead generation, feedback, quotation or offers for goods and/or services, collaboration, or other contextually relevant interaction between clients or systems, of which any or all are collectively referred to as “contextual opportunities”, to one or more first clients or systems (denoted herein as Opportunity Receivers) based upon values, inferences or data sourced or generated by one or more second clients or systems (denoted as Data Generators).

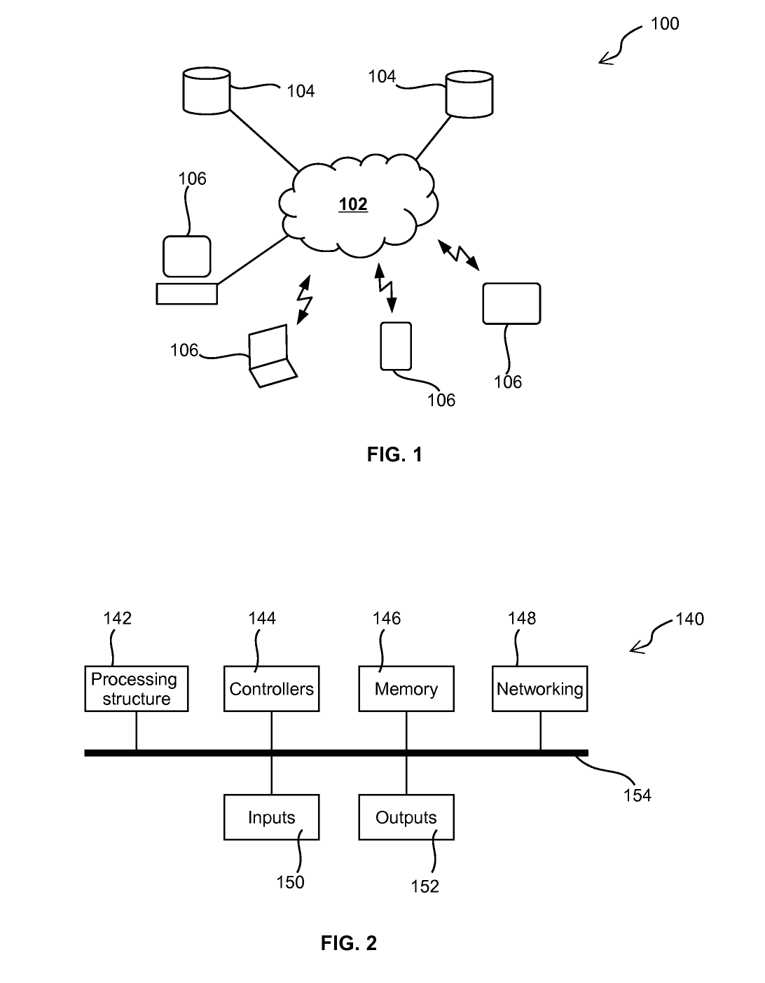

Turning to FIG. 1, a computer system 100 is illustrated. The computer system 100 comprises a computer network 102 functionally connecting to a plurality of computing devices 104 and 106. The computing devices 104 and 106 include one or more computer servers 104, and a plurality of client computing devices 106 such as tablets, smartphones, desktop computers, laptop computers, PDAs and the like. Here, the computer network 102 is a network for connecting computing devices, and may be a local area network (LAN), wide area network (WAN), metropolitan network (MAN), Internet, or the like. It may also be a wired or wireless communication network for connecting smart phones such as a 4G wireless communication network. As those skilled in the art appreciate, computer servers 104 and client computing devices 106 may connect to the network 102 via wired or wireless means, e.g., Ethernet, WiFi®, Bluetooth®, Zigbee®, or the like.

FIG. 2 shows the hardware structure 140 of a computing device 104 or 106. As shown, a computing device comprises a processing structure 142, one or more controllers 144, memory or storage 146, a networking module 148, inputs 150 and outputs 152, all functionally interconnected by a communication channel 154.

The processing structure 142 may be one or more single-core or multiple-core computing processors such as Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like.

The controllers 144 may be graphic controllers, input/output chipsets and the like, for coordinating operations of various hardware components and modules of the computing device.

The memory 146 comprises a plurality of storage units accessible by the processing structure 142 and the controllers 144 for reading and/or storing data, including input data and data generated by the processing structure 142 and the controllers 144. The memory 146 may be volatile and/or non-volatile, non-removable or removable memory such as RAM, ROM, EEPROM, solid-state memory, hard disks, CD, DVD, flash memory, or the like.

The networking module 148 comprises components for connects to other computing devices or networks via wired or wireless connections such as Ethernet, WiFi®, Bluetooth®, wireless phone channels, ZigBee®, or the like. In some embodiments, parallel ports, serial ports, USB connections may also be used for connecting other computing devices or networks.

The inputs 150 comprise one or more input interfaces for connecting to one or more input devices to receive users input. For example, the inputs 150 may comprise input interfaces for keyboard, computer mouse, trackball, touchpad, touch-sensitive screen, interactive whiteboard, microphone, scanner, or the like. The outputs 152 comprise one or more output interfaces for connecting to one or more output devices to output data to users. For example, the outputs 152 may comprise output interfaces for image display, such as monitors, LCD displays, LED displays, projectors, etc., speaker, printer, and the like. The inputs/outputs 150 and 152 may be a physically integrated part of the computing device (e.g., the display of a laptop computer or tablet), or may be a device physically separate from, but functionally coupled to, other components of the computing device (e.g., a computer mouse). Some input/output devices may be a device integrating both input and output functions (e.g., a touch-sensitive LCD monitor), and may be an integrated part of the computing device (e.g., a touch-sensitive screen of a smartphone).

The communication channel 154 interconnects various components 142 to 152 enabling them to transmit and receive data and control signals to/from each other. In this embodiment, the communication channel 154 is a system bus.

Those skilled in the art appreciate that, a computing device may comprise all components illustrated in FIG. 2, or may alternatively comprise a portion of the components shown therein, depending on the particular type of the computing device. For example, a computer server 104 may comprise a central processing unit (CPU), a storage such as Read-Only Memory (ROM), volatile and/or non-volatile Random Access Memory (RAM), solid state drive, hard drive, or the like, a network module, and other components, all connected to the CPU via one or more signal buses. However, a computer server 104 may not comprise any touch-sensitive screen or monitor, speaker, or other hardware components that are not necessary for server-related functions.

Each computing device 104 or 106 executes an operating system, which is generally a set of computer readable code executed by the processing structure 142 for managing various hardware and software components, and for supporting the execution of application programs. For example, a computer server 104 may execute an operating system such as Unix®, Linux®, Microsoft® Window NT, Microsoft® Windows 2000 Server, Microsoft® Windows Server 2012 or the like. A client computing device 106 may execute an operating system such as Microsoft® Windows®, Apple® Mac OS®, Apple® IOS™, Google Android™, Microsoft® Windows® Mobile, BlackBerry® OS, or the like. With the support of the operating system, an application program is running on the client computing device to facilitate contextual advertising, identifying opportunities and establishing transactions between two parties.

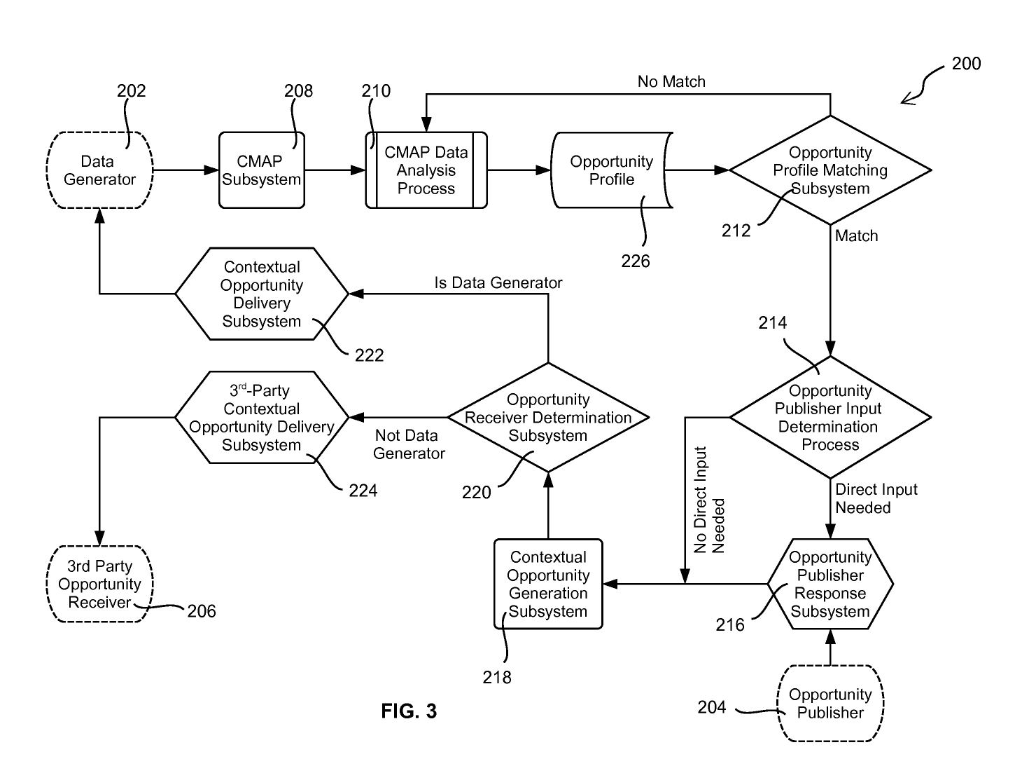

FIG. 3 illustrates a software structure 200 of the computer system 100. It also shows the interaction between the one or more server computers 104 and client computing devices 106. Here, the software structure 200 generally comprises one or more client-side application programs or program modules 202, 204 and 206, running on the client computing devices 106, and one or more server-side application programs or program modules, denoted herein as subsystems or processes 208 to 224, running on one or more server computing devices 104. The client-side programs or program modules 202 to 206 are represented in FIG. 3 using dashed-line blocks. The server-side programs or program modules 208 to 224 are represented using solid-line blocks. As skilled persons in the art appreciate, the server-side programs or program modules 208 to 224 may be running on one server computers or multiple server computers, depending on the system design and implementation.

In this embodiment, the client-side programs 202 to 206 are standalone programs exploiting known, well established web technology, each of which establishes a connection to a corresponding web server (not shown) via the networking module 148 of the respective computing device 104 or 106 through the network 102. Thus, a first user or system, denoted as a data generator 202, may generate a request or user data and submit to the system 100. As will be described in more detail below, the system 100 identifies one or more contextual transaction opportunities additional to the submitted user request or data, and distributes the identified contextual transaction opportunities to one or more second users or systems such as vendors, collaborators or service providers, denoted as opportunity publishers 204.

The opportunity publishers 204 may, in response to the system's notification, submit further information regarding the contextual transaction opportunities received from the system 100. The system 100 sends information relevant to the opportunity publishers, including the further information provided therefrom, to an opportunity receiver, which may be the data generator 202 or a third-party receiver 206 (e.g., the data generator's agent or an unrelated third party) identified by the system 100.

The opportunity receiver may select an opportunity publisher. The system then assists the opportunity receiver 202 or 206 and the opportunity publisher 204 to establish a transaction. One the transaction has been established, the system 100 transmits transaction-related data to the data generator 202 or a third party opportunity receiver 206.

As noted above, the present disclosure discloses a system and method for a data-generator-activated contextual mobile advertising or opportunity matching platform. The Contextual Mobile Advertising and Opportunity Matching platform can be active on any mobile device, personal computers or other internet-based or internet-accessible computing devices and systems, wearable computing devices, or any information-processing machines, with a variety of operating systems. A user can access the system 100 to input request or submit data. The system 100 may further request the user to answer one or more questions. The system then determines relevant and targeted Contextual Opportunities based on user-provided data and the answers the user provided during question/answer activities, and pulls these advertisements from notifications sent to participating vendors.

As shown FIG. 3, a data generator 202 submits a primary request or data, which may be text, images, audio/video clips or the like, to the CMAP subsystem 208 via the user's client computing device 106. A CMAP Data Analysis Process 222 then configures and analyzes the data received from the CMAP subsystem 208. Based on the analysis completed by the CMAP Data Analysis Process 210, one or more opportunity profiles 226 are created based on the Data Generator 202 and the Opportunities identified by the CMAP Data Analysis Process 210.

Here, the one or more opportunity profiles 226 comprises the detail of opportunities that the system 100 identified from the data submitted by the data generator 202. In the situation that the data generator 202 submitted a request, the opportunities identified by the system 100 may be the request, and may further comprise other opportunities related to the request.

In other words, in an embodiment, a data generator submits data to the system 100, including data related to a specific service or primary request. The data generator may act directly as an opportunity receiver who receives, e.g., quotes from one or more vendors regarding additional, contextual transaction opportunities that the system 100 identified from the data that the data generator submitted. Alternatively, the data generator may act through an agent, in which case the agent is the opportunity receiver to receive quotes from vendors regarding the identified contextual transaction opportunities. Alternatively, the opportunity receiver may be a third party, related or unrelated to the data generator, authorized or otherwise selected and agreeing to receive quotes from vendors regarding the identified contextual transaction opportunities.

The service provider, collaborator or vendors are opportunity publishers who deliver a response to the opportunity receiver. The primary request is the entry point for the data generator. However, the system 100 automatically identifies one or more contextual opportunities additional to the primary request, and sends the identified contextual opportunities to the opportunity publishers. Opportunity publishers may submit further information regarding the contextual opportunities in response to notification received from the system 100. The system 100 may establish a transaction between the opportunity receiver and an opportunity publisher that the opportunity receiver selects, towards an identified transaction opportunity. In this process, a primary request develops into one or more additional contextual opportunities.

An Opportunity Profile Matching Subsystem 212 determines whether opportunity profiles 226 created from the Data Generator 202 match opportunities available from the Opportunity Publishers 204 that the system has collected therefrom. If the Opportunity Profile does not match any opportunities available from the Opportunity Publishers 204, the CMAP Data Analysis Process 210 re-engages the data and repeats the above-described cycle to process other data submitted by the data generator 202.

If the Opportunity Profile matches one or more opportunities available from the Opportunity Publishers 204, the Opportunity Profile Matching Subsystem 212 pushes each matched opportunity to an Opportunity Publisher Input Determination Process 214 which determines whether or not further input is required from the corresponding Opportunity Publisher 204. If yes, the Opportunity Publisher Input Determination Process 214 pushes details of the opportunity to the Opportunity Publisher Response Subsystem 216. The Opportunity Publisher Response Subsystem 216 then prompts the Opportunity Publisher 204 to submit data or feedback relevant to the opportunity back to the system 100.

After receiving data from the opportunity publisher 204, the opportunity and the data submitted from the Opportunity Publisher 204 are sent to a Contextual Opportunity Generation Subsystem 218, which creates a Contextual Opportunity.

If, however, the Opportunity Publisher Input Determination Process 214 determines that no input is required from the Opportunity Publisher 204, the opportunity is sent to the Contextual Opportunity Generation Subsystem 218. A Contextual Opportunity is then created.

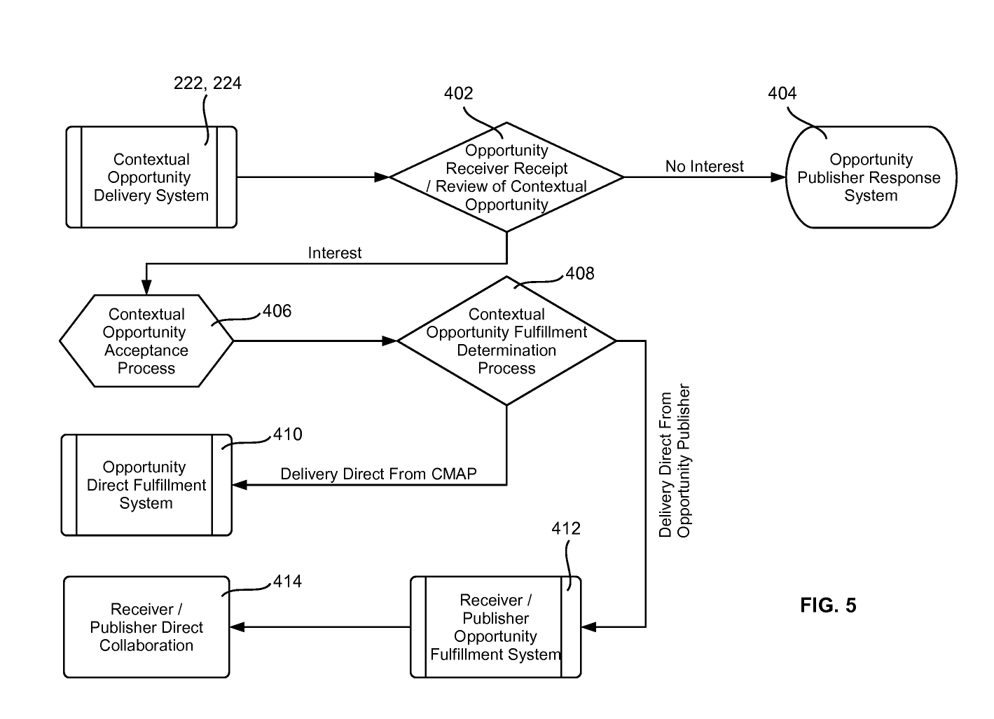

The Contextual Opportunity created by the Contextual Opportunity Generation Process 218 is delivered to the Opportunity Receiver Determination Subsystem 220. If the Opportunity Receiver Determination Subsystem 220 determines that the Opportunity Receiver corresponding to the received Contextual Opportunity is the Data Generator 202, the Contextual Opportunity is delivered to a Contextual Opportunity Delivery Subsystem 222 for sending to the Data Generator 202, the detail of which is illustrated in FIG. 5 (described later).

If, however, the Opportunity Receiver Determination Subsystem 220 determines that the Opportunity Receiver corresponding to the received Contextual Opportunity is not the Data Generator 202, the Contextual Opportunity generated in the Contextual Opportunity Generation Process 218 is pushed to a Third-Party Contextual Opportunity Delivery Subsystem 224 for delivering the Contextual Opportunity to a corresponding Third-Party Opportunity Receiver 206, the detail of which is illustrated in FIG. 5 (described later).

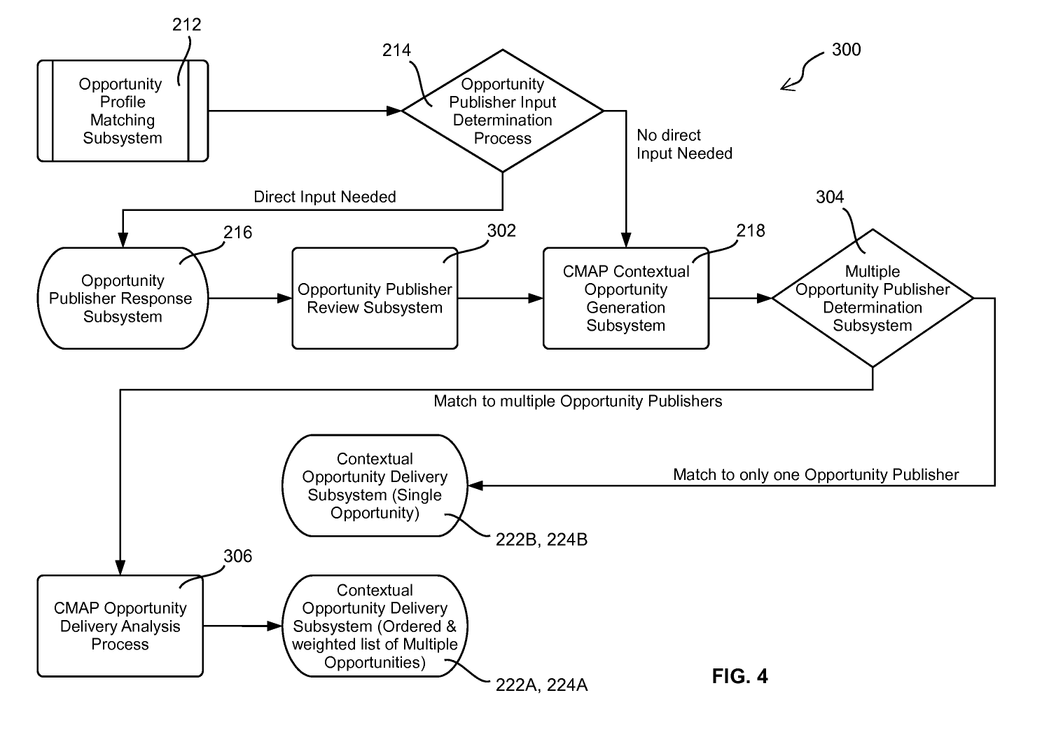

FIG. 4 shows the detail 300 of requesting and receiving data or feedback from an Opportunity Publisher 204. As shown, the Opportunity Profile Matching Subsystem 212 uses an Opportunity Profile and identifies a matching Opportunity Publisher. Once the Opportunity Profile Matching Subsystem 212 determines the match of an Opportunity Profile and an Opportunity Publisher, an Input Determination Subsystem 214 is called to assess whether or not direct input from the Opportunity Publisher is required.

If direct input is required, relevant details from the Opportunity Profile from the Opportunity Profile Matching Subsystem 212 are pushed directly to the Opportunity Publisher Response Subsystem 216 seeking a response from the Opportunity Publisher in the Opportunity Publisher Review Subsystem 302. As feedback and input is provided, amendments are made to the Opportunity Profile by the system 100, generating a Contextual Opportunity from the Contextual Opportunity Generation Subsystem 218.

If, however, the Input Determination Subsystem 214 determines that no input is required at the point of origination of the Opportunity Profile in the Opportunity Profile Matching Subsystem 212, the Opportunity Profile is used by the system 100 to automatically generate a Contextual Opportunity from the Contextual Opportunity Generation Subsystem 218 and then pushed to a Multiple Opportunity Publisher Determination Subsystem 304 which determines whether there are multiple or single Opportunity Publishers matching the Opportunity Profile.

If there are multiple matching Opportunity Publishers, the Opportunities are compiled and pushed to the CMAP Opportunity Delivery Analysis Process 306. The Contextual Opportunity Multiple Delivery Subsystem 222A or 224A, being a part of the subsystem 222 or 224 depending on whether the Opportunity Receivers are the Data Generator or third-parties, applies an ordering and weighting algorithm to the available Contextual Opportunities available from each Opportunity Publisher and delivers them to the Opportunity Receivers. If it is determined that there is only one matching Opportunity Publisher, the single Contextual Opportunity is delivered to the Opportunity Receiver via the Contextual Opportunity Single Delivery Subsystem 222B or 224B, being a part of the subsystem 222 or 224 depending on whether the Opportunity Receivers are the Data Generator or third-parties.

With reference to FIGS. 2 and 5, the reception of the Contextual Opportunity is shown that encompasses the Opportunities Delivery. The Contextual Opportunity Delivery Subsystem 222 or 224 of FIG. 3 delivers the created Contextual Opportunity to the Opportunity Receiver 202 or 206, respectively. When delivered, the Opportunity Receiver 202 or 206 is able to review the Contextual Opportunity (block 402) of FIG. 5. If there is no interest expressed, the Contextual Opportunity is pushed to an End Process 404. If there is interest expressed the Contextual Opportunity Acceptance Process 406 begins and pushes the Contextual Opportunity to the Fulfillment Determination Process 408. From the Fulfillment Determination Process 408 system determines whether direct delivery from the system is possible. If direct delivery is possible from the CMAP System, the Contextual Opportunity is sent through to the Opportunity Direct Fulfillment Subsystem 410. If direct delivery is required from the Opportunity Publisher, the Contextual Opportunity is pushed to the Receiver/Publisher Fulfillment Subsystem 412, which enables Receiver/Publisher Direct Collaboration 414.

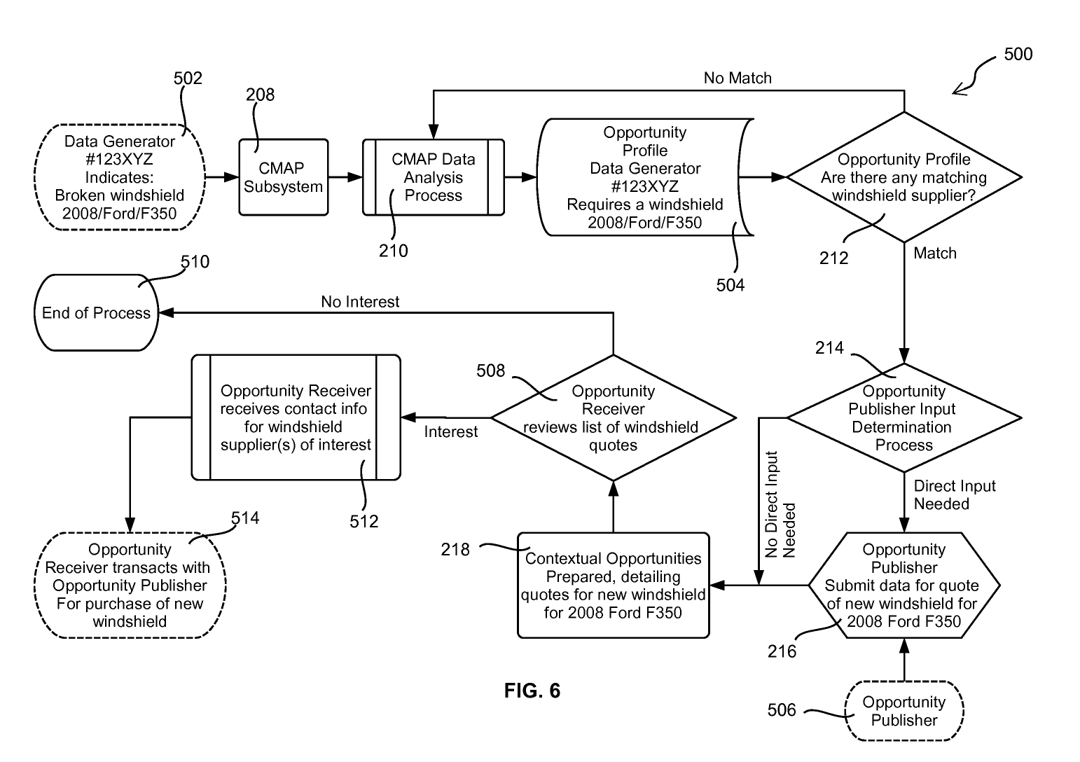

With reference to FIG. 6 an example 500 of the Contextual Mobile Advertising and Opportunity Matching Platform is shown. The Data Generator #123XYZ (denoted using numeral 502) indicates a Broken Windshield on a 2008 Ford F350. The Data created is sent to the CMAP Subsystem 208. The CMAP Subsystem 208 pushes the data into the CMAP Analysis Process 210, which creates an Opportunity Profile 504 for Data Generator #123XYZ (502).

Once the Opportunity Profile 504 has been created, the CMAP Data Analysis Process 210 pushes the Data to the Matching Determination Subsystem 212. In this case, the Matching Determination Subsystem 212 checks to see if any suppliers in the system 100 match the profile of Windshield Suppliers who can supply a windshield for this vehicle in the geographical area of the Data Generator 502. If there is no match, the Opportunity Profile 504 is sent back to the CMAP Subsystem 208 at the start of the cycle to further analyze the data.

If there is a match found, the Opportunity Profile 504 is sent to the Input Determination Process 214. If Direct Input is needed, Opportunity Publishers 506 are prompted for the submission of data to specialize their quote for “Windshield for 2008 Ford F350”. Once input is received, or if no direct input is needed to the Opportunity Profile 504, a list of Contextual Opportunities is created by the Contextual Opportunity Generation subsystem 218, which contains detailed quotes from suppliers regarding “new Windshield for 2008 Ford F350”. The Opportunity Receiver, being the Data Generator or a relevant third-party, is then able to review the list of received quotes based on the input from Data Generator 123XYZ 41 (block 508). If the Opportunity Receiver expresses no interest at block 508, the Contextual Opportunity process ends (block 510). If the Opportunity Receiver expresses interest at block 508, they are pushed to an Opportunity Fulfillment Subsystem 512 which provides contact information for the Windshield Supplier(s) of interest to the Opportunity Receiver. Once contact information has been provided, the Opportunity Receiver is given the option to transact with the available Opportunity Publisher(s)/Windshield Supplier(s) (block 514) based on the Contextual Opportunities created at block 218.

The instant disclosure discloses a computer or data systems processing method facilitating a Contextual Mobile Advertising and Opportunity Matching Platform on, and, including PCs, mobile devices, internet-based or accessible platforms, wearable computers, or any information manufacturing machine and multiple operating systems comprising: Collecting contextual data on or about Data Generators based upon specific inputs; Determining a Contextual Opportunity related to specific data inputs received from or about the Data Generator; Predicting system wide Contextual Advertising opportunities based on and related to specific Data Generation points; Presenting specific Contextual Advertising Opportunities to Vendors or Collaborators, or Associated Vendors or Collaborators, with the ability to present opportunities directly to the specific Data Generator, or Third Party Data Receivers; Selecting the Vendor or Collaborator Opportunities that are the most contextually relevant based on the specific inputs from the Data Generators; Presenting the contextually relevant vendor or collaborator opportunities directly to the Data Generators or Third Party Data Receiver; Presenting system wide, and contextually section relevant, advertising opportunities to participating Vendors or Collaborators and Associated Vendors or Collaborators based on participation in providing Contextually Relevant Opportunities to Data Generators or Third Party Data Receivers.

The method further comprising determining a Data Generator's, or Third Party Data Receiver's, current need and the necessity of the need, based on specific data inputs on, or about the Data Generator.

The method wherein the Contextual Data collected from, or about, the Data Generator comprises: The Data Generators geographical location; The Data Generators geographical location selected limits; History of the Data Generator's linked activities; The Data Generators response inputs to Data Triggers; History of the Data Generator's response inputs to Data Triggers.

The method further comprising the identification of upcoming and high priority advertising and marketing opportunities based on data collected from the Data Generator.

The method comprising the collection of contextual data inputs, and presentation of these inputs to associated vendors or collaborators accessing the Contextual Mobile Advertising and Opportunity Matching Platform.

The method wherein presenting the advertising and marketing opportunities to the Data Generator or Third Party Opportunity Receiver requires the opportunities to be presented within the Contextual Mobile Advertising and Opportunity Matching Platform and must pass relevancy checks.

The method in which the Data Generator or Third Party Opportunity Receiver must be the party to initiate communications with associated vendors or collaborators within the Contextual Mobile Advertising and Opportunity Matching Platform system once opportunity notifications have been received.

A computer readable external storage server storing instructions that when executed by a computer system, cause the computer readable external storage server to perform a method for the creation of contextual opportunities specifically based on direct data inputs by a Data Generator, the method comprises: Collecting contextual information based on specific inputs from a Data Generator; Determining and qualifying needs based on specific inputs from a Data Generator; Determining and qualifying contextually relevant opportunities based on the specific inputs of the Data Generator; Presenting the created contextual opportunity profiles to one or more associated vendors or collaborators, allowing the vendors or collaborators to create contextual opportunities that match the opportunity profiles created by the method; Presenting the created contextual opportunities with the highest and most applicable relevancy to the Data Generator or Third Party Opportunity Receivers.

The system wherein the method further comprises a determination process to determine the Data Generator's occurrence probability for future data input activities, and receptivity to contextual opportunities.

The system further comprises the presentation of assembled contextual data to relevant associated vendors or collaborators.

The system wherein presenting the advertising and marketing opportunities to the Data Generator or Third Party Opportunity Receiver requires the opportunities to be presented within the Contextual Mobile Advertising and Opportunity Matching Platform and must pass relevancy checks.

The system in which the Data Generator or Third Party Opportunity Receiver must be the party to initiate communications with associated vendors or collaborators within the Contextual Mobile Advertising and Opportunity Matching Platform system once opportunity notifications have been received.

The system wherein the Contextual Data collected from, or about, the Data Generator comprises: The Data Generators geographical location; The Data Generators geographical location selected limits; History of the Data Generator's linked activities; The Data Generators response inputs to Data Triggers; History of the Data Generator's response inputs to Data Triggers.

In some alternative embodiments, the system, after the Data Generator has submitted data thereto, asks the Data Generator one or more questions, and identifies opportunities from the answers received from the Data Generator regarding the questions the system asks.

For example, in one embodiment, the system automatically distributes notifications to specific service providers informing them that the Data Generator has answered a question within an application that contextually confirms that the Data Generator has a specific need at this point-in-time. The Data Generator answering the question to the system does not have to do or request anything but, because the Data Generator has answered a question in a specific way, the system is thus informed that the Data Generator is in need of a specific product, specific information or specific service. The system automatically matches that need with specific vendors, i.e., Opportunity Publishers, who are then prompted to offer quotes, feedback, or offerings for the product, information or service that the Data Generator needs.

The vendor has the option to provide a quote, feedback or offering for the product, information and/or service and submit that quote, feedback or offering back to the Data Generator. The Data Generator is presented with notifications that he/she can choose to view and respond to.

For example, a Data Generator is using the system to gather all the information from her car as she prepares the vehicle for sale. In using the system, the Data Generator gathers all details, including photos and video of the car. The system asks the Data Generator the following questions:

“Does your windshield have any cracks or chips? Yes or No”

If the Data Generator answers “No” then there is no need for any type of windshield service;

If the Data Generator answers “Yes” then a sub question is presented:

“What type and size of damage is present?”

The Data Generator answers: “crack—3 to 6 inches.”

At this point the system automatically sends out notifications to Opportunity Publishers, i.e., the windshield vendors in this example, that service from a user is generated in the venders' geographical area. Each vendor can choose to submit a quote for the windshield repair and send it back to the Data Generator via a notification to the system. In this manner, the Data Generator does not have to specifically request anything except answering a question that is specific to what is going on at that point-in-time. The specific values that the Data Generator uses to contextually answer that question automatically tells the system if the Data Generator is in need of something and specifically what that something is without the Data Generator specifically indicating a need.

The system disclosed herein is a platform that receives external data from any source (the Data Generator) whether through direct input or some method of receiving shared data collected through some other source, analyzes the data through some specific pre-defined parameters, compares the analyzed results to information about or from other external systems or parties (the Opportunity Publisher(s)), determines any matching “Contextual Opportunities” and delivers details of targeted, specifically relevant feedback to a specified party (the Opportunity Receiver), whether that is the source of the original external data or a third party.

This system disclosed herein receives data, analyzes it and returns feedback to a party (the Data Generator or a third-party Opportunity Receiver). The feedback returned from the system is not pre-configured advertisements that might or might not be relevant to the Data Generator or the Opportunity Receiver. Rather, the feedback returned from the system matches the need of the Data Generator or the Opportunity Receiver. In other words, it is designed to return specific, targeted opportunities or feedback specific to the information received from the Data Generator and for a specific purpose or need of the “Opportunity Receiver”. It does not return “a close enough” or “since nothing else matches” result. If nothing is matched, nothing is returned. Moreover, the system only returns data that the Opportunity Receiver wants to receive.

The system is not tied to or meant specifically only to deliver quotes for products or services, but could be used as a collaboration tool where a Data Generator needs to expose certain data or information to a selected group (who could be known or unknown to the Data Generator) in order to receive targeted and specific feedback or information of any type.

The system, in some embodiments, may infer from the data supplied by the Data Generator what is desired, if not specifically specified, and return specific, targeted Opportunities based on those inferences as well as any directly-specified desires.

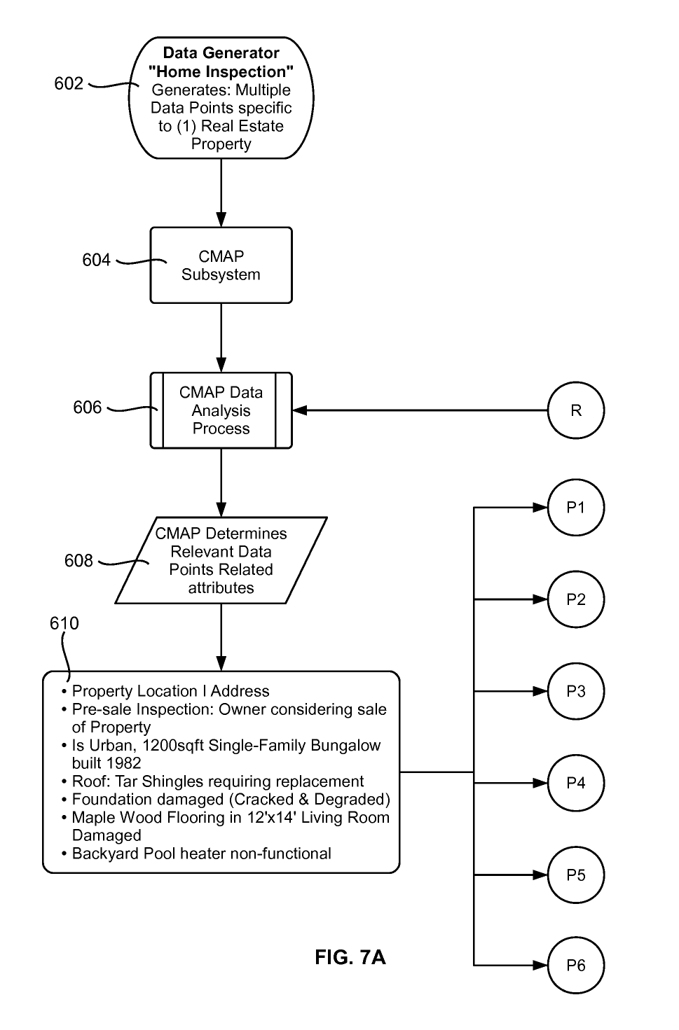

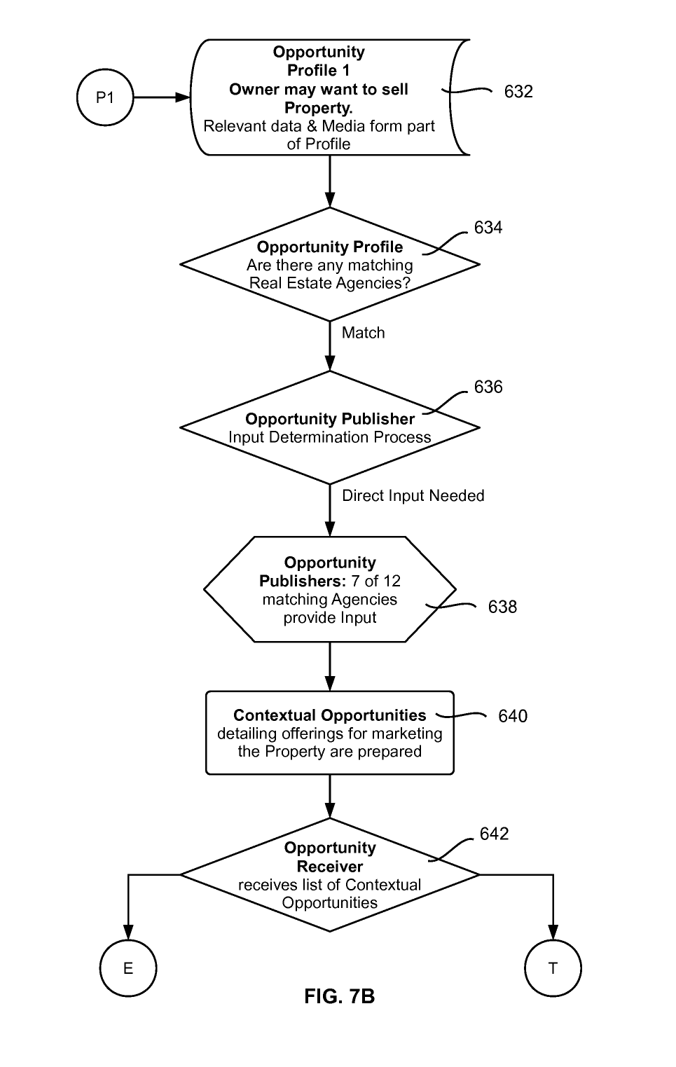

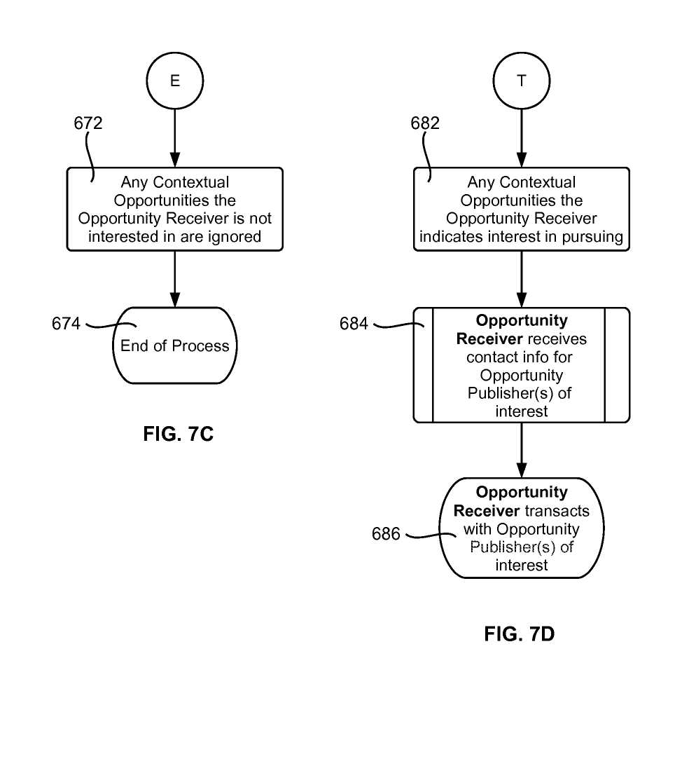

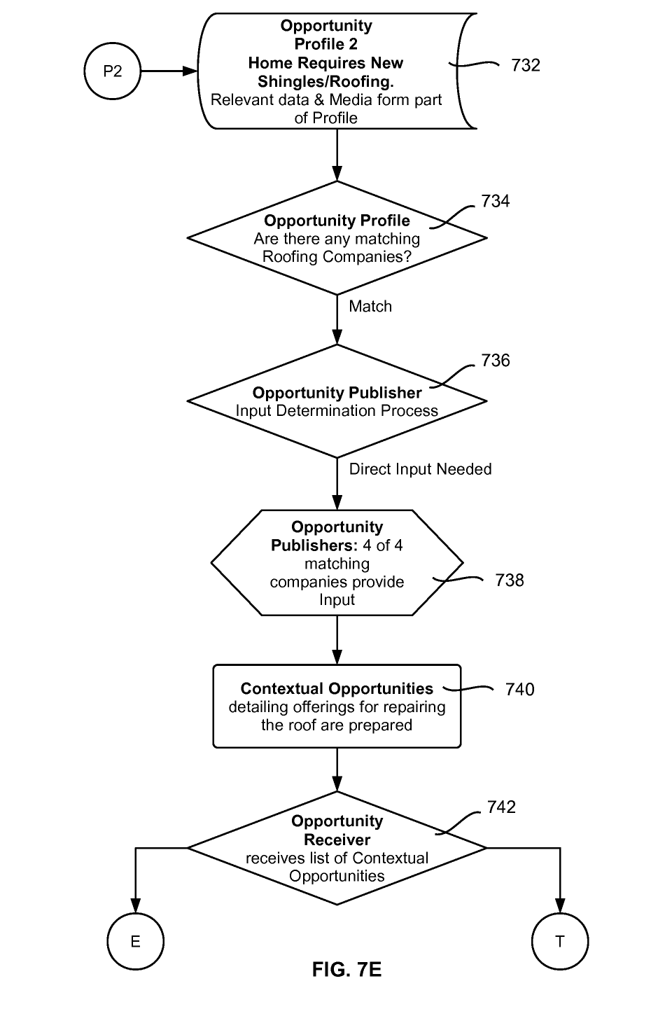

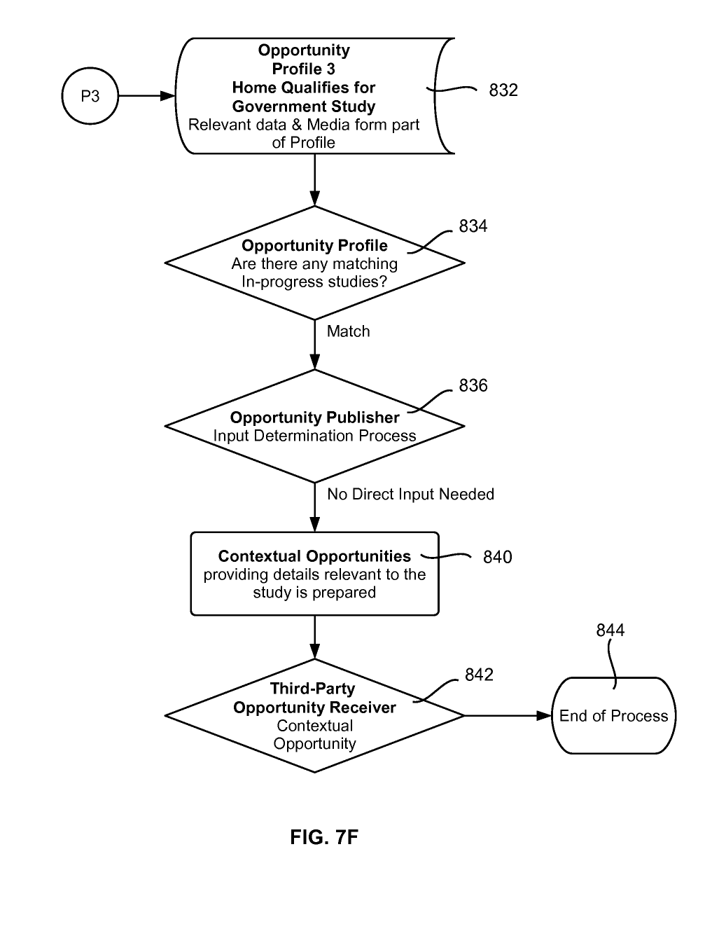

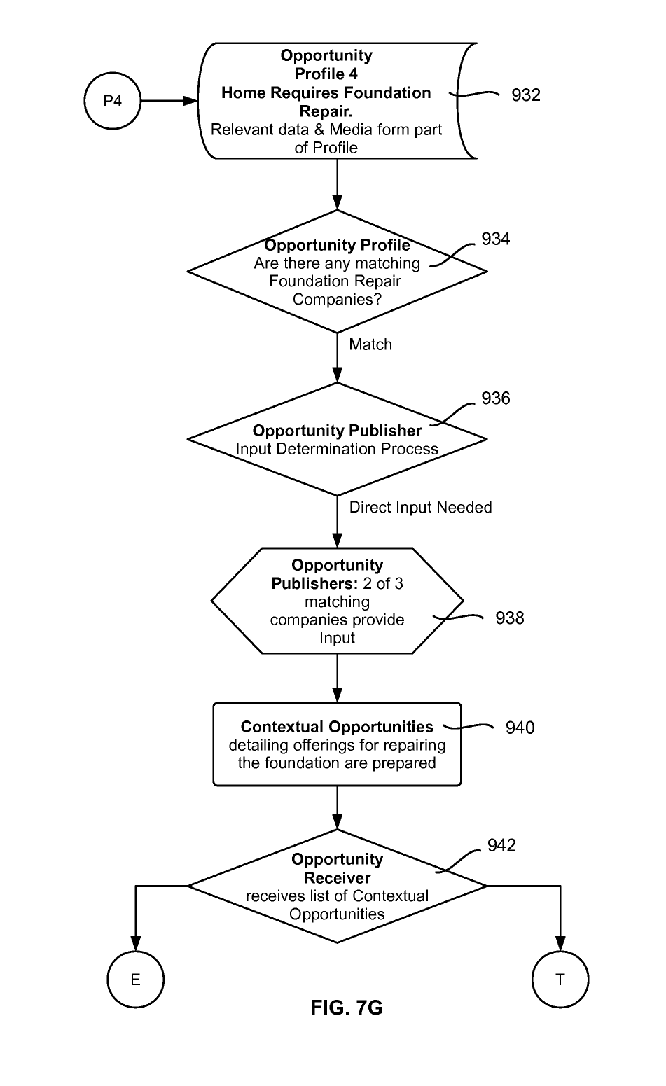

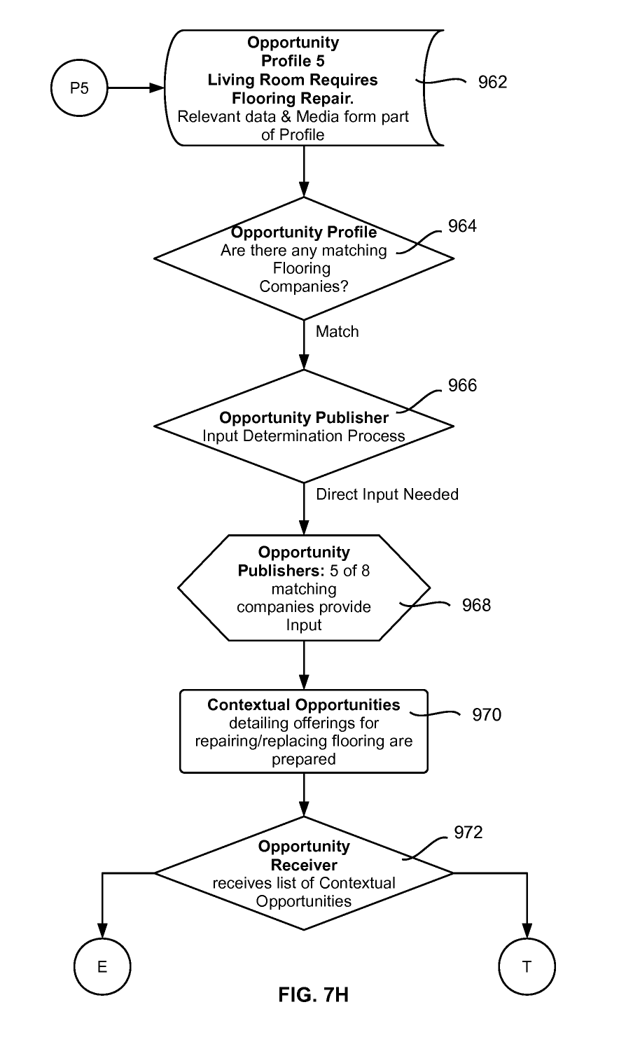

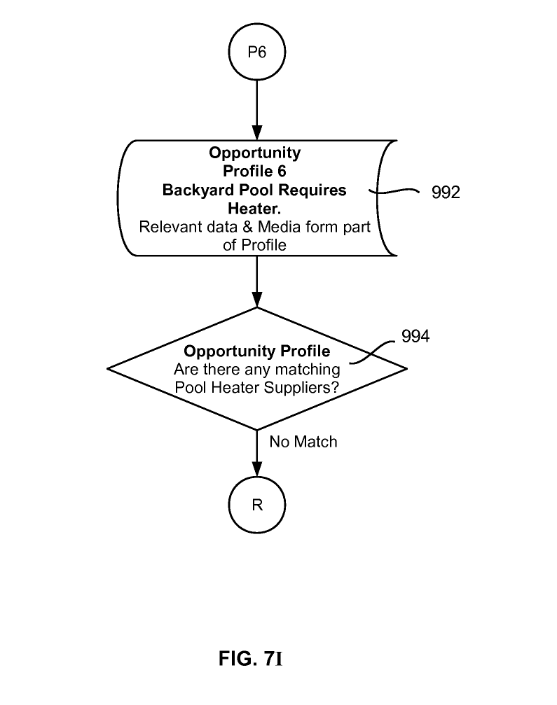

FIGS. 7A to 7I show an example scenario of real estate home inspector data input to the CMAP system, for further illustrating the functions of the system disclosed herein. In these figures, the conditioning blocks (e.g., blocks 634, 636 and 642 in FIG. 7B) that branch the process based on the result of a determination only show the branch or branches that have occurred in this example.

As shown in FIG. 7A, a real estate home inspector uses a data collection technology and a mobile tablet with integrated camera to answer a series of questions designed to capture the data, including text answers, photos & video for the specific type of property being inspected. Upon completion of the inspection, the data is uploaded to a system and produces an electronic report that the Home Inspection Company supplies to their client and uses for their own internal purposes. At that point, this data is also shared with the CMAP system 100. Thus, the Home Inspection Company is the Data Generator (block 602) in this example.

The data is input from the Data Generator into the CMAP subsystem (block 604). The CMAP Data analysis Process (block 604) analyses the data and determines relevant points of data (as well as data including more detailed, specific related attributes not listed here) (block 608). In this example, the property is located in the downtown region of ABCTown, is a 1200 square foot, single family, 3 bedroom bungalow with an un-finished basement built in 1982. It has an unfinished poured concrete basement an attached 2 car garage and one 4-piece bath upstairs and one 3 piece bath ensuite to the master bedroom. The detail of determined relevant points of data includes (block 610):

P1: This is a “Pre-Sale Inspection” of the property ordered by the Property owner who is considering selling the property

P2: The roof consists of tar shingles that are past their life-expectancy and require replacement

P3: Physical Location of the Property—The property consists of an urban, 1200 square foot, single-family bungalow built in 1982

P4: The foundation in 2 spots is showing evidence of structural degradation and cracking

P5: Maple Hardwood Flooring in the living room (size 12′ long×14′ wide) is showing water damage & other major wear

P6: A backyard in-ground pool shows structurally in excellent condition, but the water heater for the system is defective and non-functional

The CMAP system 100 develops an Opportunity Profile for each of these relevant points, i.e., 6 Opportunity Profiles in this example, and accesses its list of “Opportunity Publishers” within defined geographic parameters relevant to the property's physical location, determines any matches that are relevant and returns the different “Contextual Opportunities” to the relevant “Opportunity Receivers”. Note that it is assumed in this scenario that the Home Inspection Company and/or their client have provided any necessary permissions to share this data with any “Opportunity Publishers” and receive any resultant “Contextual Opportunities”.

Opportunity Profile #1: The current owner is considering selling the property, but has not yet listed it for sale.

The processing of Opportunity Profile #1 branches from block 610 to connector P1 in FIG. 7B.

The Opportunity Profile is generated with this information along with photos, video and other specifics of the house & property (block 632). The system determines that there are real estate agencies (i.e., the Opportunity Publishers for this Opportunity Profile) matching this Opportunity Profile (block 634), and delivers the Opportunity Profile to 12 matching Real Estate Agencies that the CMAP system has on record as offering services in downtown ABCTown and that sell this type of property. At block 636, the system also determines that direct input is required from the Opportunity Publishers, and notifies them to provide input.

At block 638, 7 of these 12 Real Estate Agencies respond with their desire to offer their services to sell the home, resulting in 7 different Contextual Opportunities (block 640).

The 7 Contextual Opportunities are delivered to the Opportunity Receiver (block 642), which may be the Home Inspection Company (the “Data Generator”) or the actual property owner (a Third Party Opportunity Receiver).

If the Opportunity Receiver is the Home Inspection Company, they could offer this as a free, goodwill (or even paid) service to their client indicating that they have 7 different parties interested in selling this specific property and provide the info to the property owner, if the owner indicates it is desired, as a way of promoting the Home Inspection Company and maintaining future goodwill with the property owner.

If the Opportunity Receiver is the property owner, the 7 Contextual Opportunities would be delivered direct. This could possibly also come with a message from the Home Inspection Company as an indication of a free offering as a promotional/goodwill gesture.

Thus, the system receives indication of desire from the Opportunity Receiver, and branches the process to connector E in FIG. 7C or connector T in FIG. 7D.

FIG. 7C shows the processing of the Contextual Opportunities that the Opportunity Receiver is not interested in. As shown, such Contextual Opportunities are ignored (block 672) and the process is terminated (block 674).

FIG. 7D shows the processing of the Contextual Opportunities that the Opportunity Receiver is interested in. As shown, such Contextual Opportunities are pursued (block 672). The Opportunity Receiver receives contact information of the Opportunity Publisher(s) of interest (block 684). The system the assist the

Opportunity Receiver and the corresponding Opportunity Publisher(s) to establish a transaction (block 686).

Opportunity Profile # 2: This home requires new shingles or other roofing material.

The processing of Opportunity Profile #2 branches from block 610 in FIG. 7A to connector P2 in FIG. 7E.

The home is located in the downtown region of ABCTown, is a 1200 square foot bungalow with a traditional gable roof design. The Opportunity Profile is generated with this information along with any relevant photos & video (only media depicting the roof and/or exterior of the building are relevant and need to be supplied), providing enough information for any roofing contractor to provide an estimate to repair the roof (block 732).

The system determines that there are roofing companies (i.e., the Opportunity Publishers for this Opportunity Profile) matching this Opportunity Profile (block 734), and delivers the Opportunity Profile to 4 different roofing companies that the CMAP system has on record as offering services in downtown ABCTown and that provide services for this type of property. At block 734, the system also determines that direct input is required from the Opportunity Publishers, and notifies them to provide input.

At block 738, all 4 companies respond with their desire to offer their services to repair this roof. Some reply with specific dollar value quotations for replacing the roofing material with an equivalent product and some supply multiple quotations providing options using differing types of roofing materials and one replies with information that they need to make an appointment to physically view the property in order to be able to provide an accurate quote. This results in 4 different Contextual Opportunities (block 740).

These Contextual Opportunities are delivered to the Opportunity Receiver (block 742), which could be either the property owner or the Home Inspection Company as described above regarding Opportunity Profile #1. The system receives indication of desire from the Opportunity Receiver, and branches the process to connector E in FIG. 7C or connector T in FIG. 7D, as described above.

Opportunity Profile #3: The local government has mandated a study to determine how many properties may qualify for a “Green Home Upgrade & Renovation Grant” program being considered for the following calendar year. As research for this study, it is desired to determine how many homes of an age 25 years and older, smaller than 1500 square feet and located in low-income areas of certain major urban centers may qualify for rebates as well as relevant specifics of these properties.

The processing of Opportunity Profile #3 branches from block 610 to connector P3 in FIG. 7F.

The Opportunity Profile is generated with the following information, all contained in the original data received from the Data Generator (block 832):
The home is located at 123 Somewhere Lane in ABCTown;
It is 1200 square feet in size, is a single family bungalow and is 32 years old;
It has a tar-shingle roof needing replacement, a stucco exterior built around a 2×4 framed structure with pink fiberglass R12 insulation in the walls and pink fiberglass R20 insulation in the roof. Windows are double pane, aluminum frame windows and original to the house;
The home has its original, inefficient, gas-fired forced air furnace, built in 1982, and located in the basement. It also has a 15 year old mid-efficiency electric hot water heater;
The home has an unfinished and un-insulated poured concrete walled basement with a 3″ thick poured concrete floor.

The CMAP system determines that this home matches the qualifications for being statistically relevant for this study (block 834). At block 636, the system also determines that no direct input is required from the Opportunity Publisher, which is the firm producing the study for the government (a Third Party Opportunity Receiver). The Contextual Opportunity is then delivered to the Opportunity Receiver (block 842), possibly including relevant photos & video if required, providing more than adequate information for statistical analysis. The process then ends (block 844).

Opportunity Profile #4: This home has a damaged foundation.

The processing of Opportunity Profile #4 branches from block 610 to connector P4 in FIG. 7G.

The home is located in the downtown region of ABCTown. Photos & video of the damage from both inside & outside of the home as well as any relevant details, including the measured size of the cracks & other damaged areas is provided. It is indicated that the damage is in a poured concrete portion of the basement walls/foundation. The Opportunity Profile is generated with this information (block 932).

The system determines that there are foundation repair companies (i.e., the Opportunity Publishers for this Opportunity Profile) matching this Opportunity Profile (block 934), and delivers the Opportunity Profile to 3 foundation repair companies that the CMAP system has on record as offering foundation repair services in downtown ABCTown and that provide services for this type of property. At block 936, the system also determines that direct input is required from the Opportunity Publishers, and notifies them to provide input.

At block 938, in reviewing the detailed information, pictures & video supplied, one of these 3 companies declines interest in the job as it is apparent to them that these repairs are outside of their scope of expertise. The other 2 companies indicate interest, providing estimates of repair but requesting a personal inspection of the building in order to confirm their quotations, resulting in 2 Contextual Opportunities (block 940).

These 2 Contextual Opportunities are delivered to the Opportunity Receiver (block 942), which could be either the property owner or the Home Inspection Company as described above regarding Opportunity Profile #1. The system receives indication of desire from the Opportunity Receiver, and branches the process to connector E in FIG. 7C or connector T in FIG. 7D, as described above.

Opportunity Profile #5: The 12′×14′ living room in the home is finished with 2″ wide maple hardwood flooring original to the house. It is showing major water damage to an area approximately 2′ square and scratches & scuffs to most of the remaining area of the floor.

The processing of Opportunity Profile #5 branches from block 610 to connector P5 in FIG. 7H.

The Opportunity Profile is generated with this information along with relevant photos, video and other relevant specifics of the house (block 962). The system determines that there are flooring companies (i.e., the Opportunity Publishers for this Opportunity Profile) matching this Opportunity Profile (block 964), and delivers the Opportunity Profile to 8 different flooring companies that the CMAP system has on record as offering services in downtown ABCTown and that provide services for this type of property. At block 966, the system also determines that direct input is required from the Opportunity Publishers, and notifies them to provide input.

At block 968, 3 of the 8 flooring companies determine this job is too small for them and do not respond to the Opportunity; 4 of the 8 flooring companies reply with quotations for replacement of the floor with new material, sometimes offering different quotations for different types of quality of hardwood; and 1 of the 8 flooring companies replies with a quotation for replacement of the floor, but also with a quotation indicating a cost for repair of the floor including replacement of the damaged wood (since the company happens to have a small quantity of used flooring that is an exact match for this flooring from a previous floor replacement that required removal of original flooring from a similar-vintage home) and refinishing of the complete floor.

This results in multiple Contextual Opportunities (block 970) that are delivered to the Opportunity Receiver (block 972), which could be either the property owner or the Home Inspection Company as described above regarding Opportunity Profile #1. The system receives indication of desire from the Opportunity Receiver, and branches the process to connector E in FIG. 7C or connector T in FIG. 7D, as described above.

In the processing of Opportunity Profile #5, the property owner elects to accept the Contextual Opportunity provided by the flooring company offering repair of the floor (block 682 of FIG. 7D) since it was ⅓ the cost of the lowest quotation for complete floor replacement, providing a savings for the property owner and a job for the flooring company that they may otherwise have missed out on if not provided specific, detailed, targeted information that was specific to the information supplied by the “Data Generator”. The Opportunity Receiver, i.e., the property owner receives the contact info for the Opportunity Publisher of interest, i.e., the selected flooring company (block 684 of FIG. 7D). The system then establishes a transaction between the property owner and the selected flooring company (block 686 of FIG. 7D).

Opportunity Profile #6: This home has a backyard pool which requires a heating system.

The processing of Opportunity Profile #6 branches from block 610 to connector P6 in FIG. 7I.

The home is located in the downtown region of ABCTown. Photos of the damaged equipment & of the pool are supplied as well as the make, model, serial # and other information relevant to the pool and pool heating equipment. The Opportunity Profile is generated with this information (block 992).

The CMAP system cannot identify any Opportunity Publishers offering pool equipment repair or supply services within the specified geographical area of this property (block 994). No “Contextual Opportunities” are generated, and the process goes to connector R in FIG. 7A, and returns to block 606 to process other requests.

The scenario shown in FIGS. 7A to 7I provides an example of how detailed information provided by a Data Generator to the CMAP system results in a variety of specific, targeted Opportunity Profiles delivered to a variety of Opportunity Publishers resulting in a large quantity of Contextual Opportunities that are specific and relevant to the needs of various, different Opportunity Receivers for a variety of different, unrelated purposes & outcomes, which are determined from one data set obtained from one source.

In an alternative embodiment, the system 100 determines whether or not the data submitted from the Data Generator comprises a primary request. If the data submitted from the Data Generator comprises a primary request, the system 100 identifies a user relevant to the primary request, e.g., a vendor or service provider who can meet the requirement of the primary request, and establishes a transaction between the Data Generator and the identified user towards the primary request.

In above embodiments, the system 100 may comprises a suitable subsystem and method for establishing a transaction between two users. For example, the system 100 may comprises an electrical transaction subsystem for sending the Opportunity Receiver and the Opportunity Publisher that the Opportunity Receiver has selected an electrical contract document, receiving the electrical contract document electronically signed by the Opportunity Receiver. After receiving the electronically signed contract document from both parties, the transaction subsystem transfers an amount designated in the signed contract document from an account of the Opportunity Receiver to an account of the Opportunity Publisher to establish the transaction.

What is claimed is:

1. A computerized method for establishing a transaction or collaboration, comprising:
receiving data from a first user or system regarding a request;
identifying, by analyzing the received data, at least one contextual transaction opportunity additional to said request;
identifying at least one opportunity publisher for the at least one contextual transaction opportunity;
sending the at least one contextual transaction opportunity to the at least one opportunity publisher;
determining whether or not further information related to the at least one contextual transaction opportunity is required from the at least one opportunity publisher;
requesting the at least one opportunity publisher to provide further information related to the at least one contextual transaction opportunity, if further information related thereto is required;
delivering, to a receiver, information relevant to the at least one opportunity publisher;
receiving, from the receiver, a selection of one of the at least one opportunity publisher; and
establishing a transaction or collaboration between the receiver and the selected one of the at least one opportunity publisher.

2. The method of claim 1 wherein said receiver is the first user or system.

3. The method of claim 1 wherein said receiver is a second user or system different to the first user or system.

4. The method of claim 1 further comprising:
identifying a third user or system relevant to said primary request; and
establishing a transaction or collaboration between the first user or system and the third user or system.

5. The method of claim 1 wherein identifying at least one contextual transaction opportunity additional to said request comprises:
presenting at least one question to the first user or system;
receiving answer from said first user or system regarding the at least one question; and
identifying at least one contextual transaction opportunity from the received answer.
